(19) United States
(12) Patent Application Publication
(10) Pub. No.: US 2025/0112549 A1
(43) Pub. Date: Apr. 3, 2025

(54) BIDIRECTIONAL SWITCHED CAPACITOR CONVERTER WITH CURRENT LIMITING AND CONTROL CIRCUIT AND CONTROL METHOD THEREOF

(71) Applicant: Richtek Technology Corporation, Zhubei City (TW)

(72) Inventors: Kuo-Chi Liu, Hsinchu (TW); Ta-Yung Yang, Taoyuan (TW)

(21) Appl. No.: 18/661,934

(22) Filed: May 13, 2024

Related U.S. Application Data
(60) Provisional application No. 63/587,178, filed on Oct. 2, 2023.

(51) Int. Cl. H02M 3/07; H02M 1/00; H02M 3/156

(52) U.S. Cl. CPC H02M 3/07; H02M 1/0009; H02M 3/156

(57) ABSTRACT

A switched capacitor converter for converting a first voltage into a second voltage and vice versa, includes: a plurality of switches which includes at least four switches, with a first switch included, which is coupled between the first voltage and an inductor switching node; an inductor coupled between the inductor switching node and the second voltage; a flying capacitor coupled to the plurality of switches and configured as a capacitive voltage divider; a current sense circuit for detecting an inductor current and sampling the inductor current during the first switch's turn-on state to generate a sensed current signal; an error amplifier for comparing the sensed current signal with a reference current signal to generate a first amplified signal; and a PWM generator for comparing the first amplified signal with a ramp signal for generating switching control signals to control a first switch current flowing to or from the first voltage.

### CROSS REFERENCE

The present invention claims priority to U.S. 63/587,178 filed on Oct. 2, 2023.

### BACKGROUND OF THE INVENTION

### Field of Invention

The present invention relates to a bidirectional switched capacitor converter. Particularly it relates to a bidirectional switched capacitor converter with current limiting. The present invention also relates to a control circuit and a control method for controlling the above bidirectional switched capacitor converter.

### Description of Related Art

FIG. 1 shows a prior art switched capacitor converter 900 with current limiting. The input current limit function in FIG. 1 needs a sensing resistor Rs connected at input voltage Vin for sensing an input current Iin, a current sensing amplifier 90 and a control circuit 91 to control a power stage 92. The control circuit 91 generates a control signal PWM according to a sense signal Ise and a reference current signal Iref, to control the power stage 92 for limiting input current Iin.

The disadvantages of the prior art include that the sensing resistor causes significant power loss and a high-voltage current sensing amplifier circuit is required, which results in unnecessary power consumption and higher fabrication cost.

In view of the above, to overcome the drawbacks in the prior art, the present invention proposes a bidirectional switched capacitor converter with current limiting, which features input current sensing through an output inductor for input current limit control so that a sensing resistor and a high-voltage current sensing amplifier circuit are not needed. This invention also features input current limit and current regulation control for power converters to avoid input power supply shutdown issue due to over current protection.

### SUMMARY OF THE INVENTION

From one perspective, the present invention provides a switched capacitor converter configured to convert a first voltage into a second voltage and vice versa, comprising: a plurality of switches, including at least four switches, with a first switch included, wherein the first switch is coupled between the first voltage and a first inductor switching node; a first inductor coupled between the first inductor switching node and the second voltage; a first flying capacitor coupled to the plurality of switches and configured as a capacitive voltage divider to reduce voltage stress to the plurality of switches; a current sense circuit coupled with the first inductor for detecting a first inductor current flowing through the first inductor and sampling the first inductor current during the first switch's turn-on state to generate a sensed current signal; a first error amplifier configured to compare the sensed current signal with a reference current signal to generate a first amplified signal; and a PWM generator configured to compare the first amplified signal with a first ramp signal for generating switching control signals to control the plurality of switches to control a first switch current flowing to or from the first voltage.

In one embodiment, the current sense circuit includes a sense resistor and a sense capacitor coupled to the first inductor for sensing the first inductor current by sensing the voltage across the sense capacitor to generate the sensed current signal.

In one embodiment, the current sense circuit includes a sampling circuit and a low-pass filter for detecting the first inductor current and generating the sensed current signal.

In one embodiment, the current sense circuit samples the first inductor current during the first switch's turn-on state for input current limit control for the first switch current.

In one embodiment, the current sense circuit samples the first inductor current further during the first switch is operated at OFF state for output current limit control for an output current flowing to the second voltage.

In one embodiment, the first ramp signal operates with a fixed switching frequency for the switched capacitor converter.

In one embodiment, the switched capacitor converter further comprising a second error amplifier configured to compare the second voltage with a reference voltage signal to generate a second amplified signal for controlling the second voltage.

In one embodiment, the switching control signals includes a first switching control signal and a second switching control signal; wherein the PWM generator includes a first comparator configured to compare the first amplified signal with the first ramp signal for generating the first switching control signal and a second comparator configured to compare the first amplified signal with a second ramp signal for generating second switching control signal, wherein the plurality of switches are controlled by the first switching control signal and the second switching control signal for controlling the first switch current flowing to or from the first voltage; wherein a starting time point of a pulse of the first control signal determines a first valley of the first inductor current, and a starting time point of a pulse of the second control signal determines a second valley of the first inductor current, thereby achieving valley current mode control for the switched capacitor converter; wherein the first ramp signal and the second ramp signal are generated based on a first clock signal and a second clock signal respectively, and are related to the inductor current signal.

In one embodiment, a phase shift between the first ramp signal and the second ramp signal is 180 degrees to ensure balanced control of the switched capacitor converter.

In one embodiment, the switched capacitor converter further comprising: a second switch, a third switch, and a fourth switch, where the first switch is coupled between the first voltage and a first capacitor switching node, the first flying capacitor is coupled between the first capacitor switching node and a second capacitor switching node, the second switch is coupled between the first capacitor switching node and the first inductor switching node, the third switch is coupled between the second capacitor switching node and the first inductor switching node, and the fourth switch is coupled between the second capacitor switching node and a ground potential.

In one embodiment, the switched capacitor converter further comprising a second inductor, and the plurality of switches further including a second switch, a third switch, and a fourth switch, wherein the first flying capacitor is coupled between the first capacitor switching node and the first inductor switching node, the second switch is coupled between the first capacitor switching node and a second inductor switching node, the third switch is coupled between the second inductor switching node and a ground potential, the fourth switch is coupled between the first inductor switching node and a ground potential, and the second inductor is coupled between the second inductor switching node and the second voltage.

In one embodiment, the switched capacitor converter further comprising a second inductor and a second flying capacitor, wherein the plurality of switches, the first inductor, the second inductor, the first flying capacitor, and the second flying capacitor are configured as a cross-coupled switched capacitor converter.

From another perspective, the present invention provides a control circuit configured to operably control a switched capacitor converter which is configured to convert a first voltage into a second voltage and vice versa, wherein the switched capacitor converter includes: a plurality of switches which include at least four switches with a first switch included, wherein the first switch is coupled between the first voltage and a first inductor switching node; a first inductor coupled between the first inductor switching node and the second voltage; and a first flying capacitor coupled to the plurality of switches and configured as a capacitive voltage divider to reduce voltage stress to the plurality of switches; wherein the control circuit comprises: a current sense circuit coupled with the first inductor for detecting a first inductor current flowing through the first inductor and sampling the first inductor current during the first switch's turn-on state to generate a sensed current signal; a first error amplifier configured to compare the sensed current signal with a reference current signal to generate a first amplified signal; and a PWM generator configured to compare the first amplified signal with a first ramp signal for generating switching control signals to control the plurality of switches to control a first switch current flowing to or from the first voltage.

From another perspective, the present invention provides a control method configured to operably control a switched capacitor converter which is configured to convert a first voltage into a second voltage and vice versa, wherein the switched capacitor converter includes: a plurality of switches which include at least four switches with a first switch included, wherein the first switch is coupled between the first voltage and a first inductor switching node; a first inductor coupled between the first inductor switching node and the second voltage; and a first flying capacitor coupled to the plurality of switches and configured as a capacitive voltage divider to reduce voltage stress to the plurality of switches; wherein the control method comprises: generating a sensed current signal by detecting a first inductor current flowing through the first inductor and by sampling the first inductor current during the first switch's turn-on state; generating a first amplified signal by comparing the sensed current signal with a reference current signal; and generating switching control signals to control the plurality of switches by comparing the first amplified signal with a first ramp signal, to control a first switch current flowing to or from the first voltage.

The present invention offers several advantages by enhancing efficiency and reducing complexity in electronic circuits. It eliminates the need for a high side input current sense resistor and a high voltage current sense amplifier circuit, which helps in removing the power loss typically associated with input current sense resistors. Additionally, this invention supports input current limit and/or current regulation functions, which prevents the input power supply from shutting down due to overcurrent protection. Moreover, it reduces the number of components required, leading to lower overall costs.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a prior art switched capacitor converter.

FIG. 2A shows a block diagram of a switched capacitor converter according to an embodiment of the present invention.

FIG. 2B shows a block diagram of a switched capacitor converter according to another embodiment of the present invention.

FIG. 3A shows operating waveforms corresponding to an embodiment of the switched capacitor converter shown in FIG. 2A according to the present invention.

FIG. 3B shows operating waveforms corresponding to another embodiment of the switched capacitor converter shown in FIG. 2A according to the present invention.

FIG. 4 shows a schematic diagram of a switched capacitor converter according to an embodiment of the present invention.

FIG. 5 shows a schematic diagram of a current signal generator of a current sense circuit in a switched capacitor converter according to an embodiment of the present invention.

FIG. 6 shows a schematic diagram of a sampling circuit and a low-pass filter of a current sense circuit in a switched capacitor converter according to an embodiment of the present invention.

FIG. 7A shows a schematic diagram of a switched capacitor converter according to an embodiment of the present invention.

FIG. 7B shows operating waveforms corresponding to the switched capacitor converter shown in FIG. 7A according to an embodiment of the present invention.

FIG. 8A shows a schematic diagram of a switched capacitor converter according to an embodiment of the present invention.

FIG. 8B shows operating waveforms corresponding to the switched capacitor converter shown in FIG. 8A according to an embodiment of the present invention.

FIG. 9A shows a schematic diagram of a switched capacitor converter according to an embodiment of the present invention.

FIG. 9B shows operating waveforms corresponding to the switched capacitor converter shown in FIG. 9A according to an embodiment of the present invention.

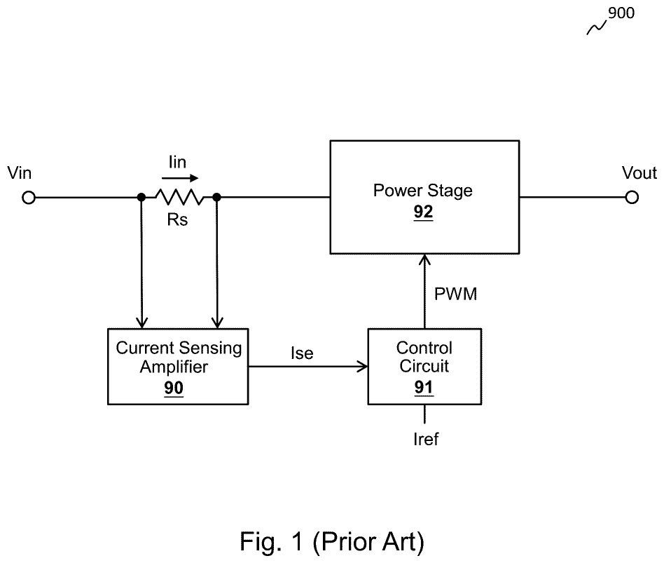

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

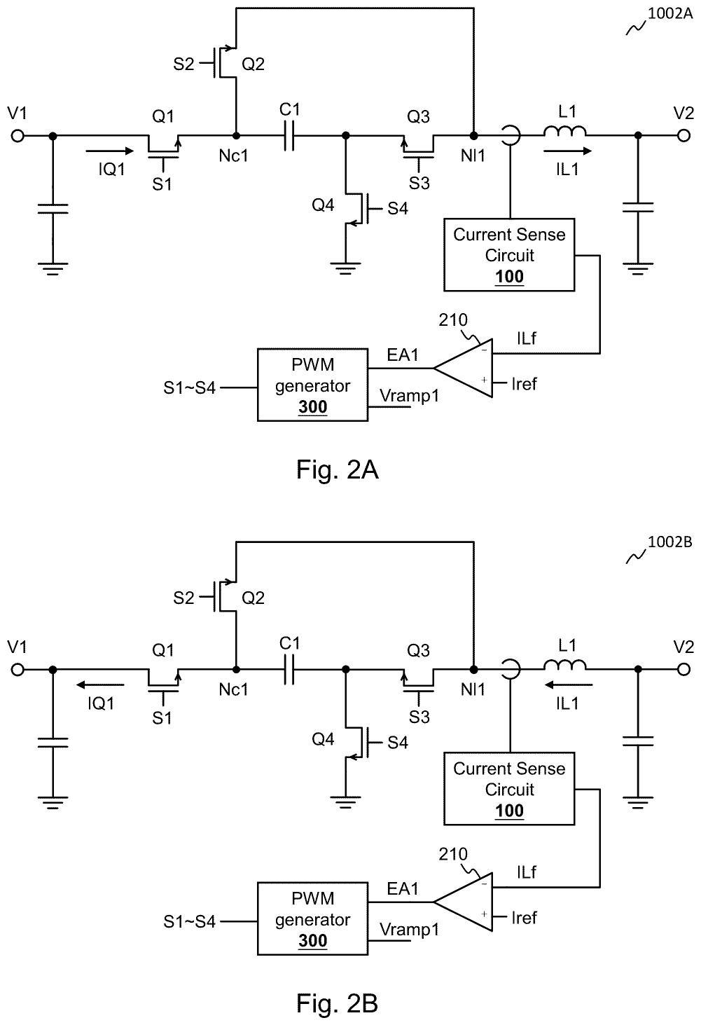

FIG. 2A shows a block diagram of a switched capacitor converter according to an embodiment of the present invention. FIG. 2B shows a block diagram of a switched capacitor converter according to another embodiment of the present invention. In one embodiment, as shown in FIG. 2A, a switched capacitor converter 1002A is configured to convert a first voltage V1 into a second voltage V2. In another embodiment, as shown in FIG. 2B, a switched capacitor converter 1002B is configured to convert the second voltage V2 into the first voltage V1. The following embodiment will be described with reference to FIG. 2A, and those skilled in the art can infer the operational details of the embodiment of FIG. 2B from the description below.

In one embodiment, as shown in FIG. 2A, the switched capacitor converter 1002A comprises: a plurality of switches, a first inductor L1, a first flying capacitor C1, a current sense circuit 100, a first error amplifier 210, and a PWM generator 300. In one embodiment, the plurality of switches includes at least four switches, in this embodiment, the plurality of switches includes a first switch Q1, a second switch Q2, a third switch Q3, and a fourth switch Q4. In one embodiment, the first switch Q1 is coupled between the first voltage V1 and a first inductor switching node Nc1. The first inductor L1 is coupled between the first inductor switching node Nl1 and the second voltage V2. The first flying capacitor C1 is coupled to the plurality of switches (Q1˜Q4) and configured as a capacitive voltage divider to reduce voltage stress to the plurality of switches (Q1˜Q4).

In one embodiment, the current sense circuit 100 is coupled with the first inductor L1 for detecting a first inductor current IL1 flowing through the first inductor L1 and for generating a sensed current signal ILf. The first error amplifier 210 is configured to compare the sensed current signal ILf with a reference current signal Iref to generate a first amplified signal EA1. The PWM generator 300 is configured to compare the first amplified signal EA1 with a first ramp signal Vramp1 for generating switching control signals S1˜S4 to control the plurality of switches, so as to control a first switch current IQ1 flowing from the first voltage V1, for input current limit control. In this embodiment, the switching control signals S1˜S4 are configured to control the plurality of switches Q1˜Q4 respectively. In one embodiment, the current sense circuit 100 is configured to sample the first inductor current IL1 during a turn-on state of the first switch Q1 to generate the sensed current signal ILf. In one embodiment, the first ramp signal Vramp1 operates with a fixed switching frequency for the switched capacitor converter 1002A.

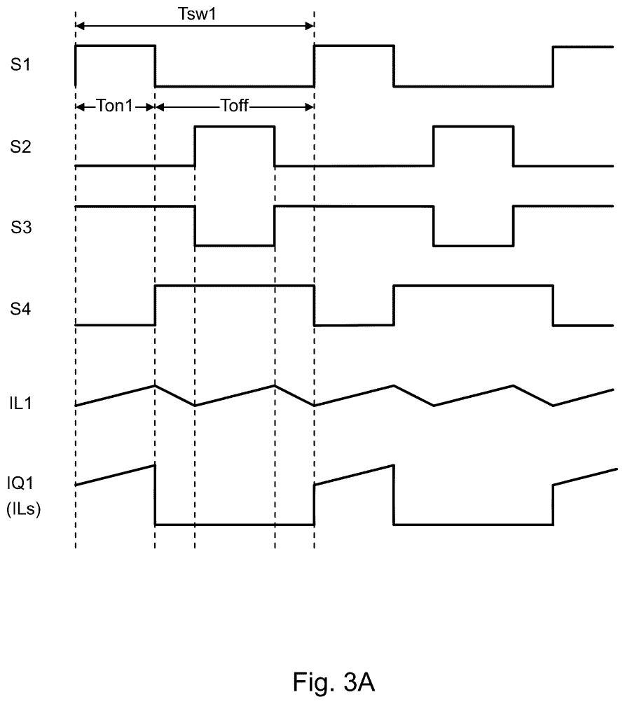

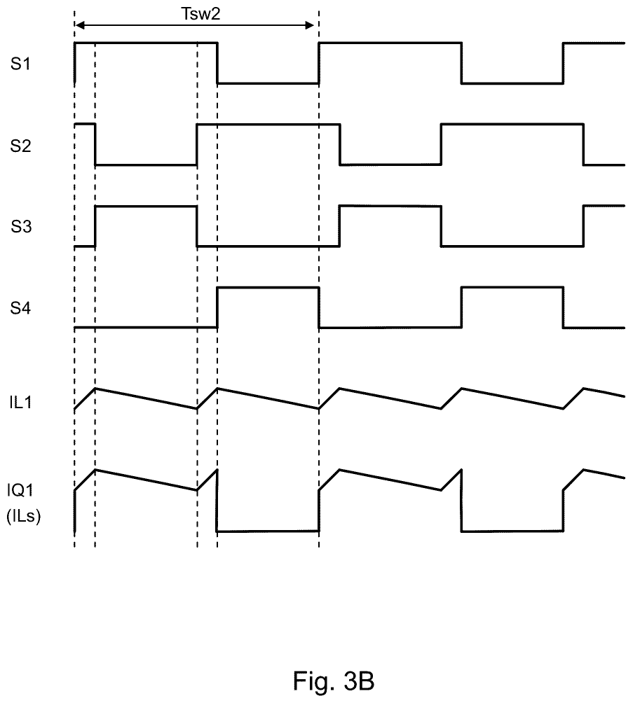

FIG. 3A shows operating waveforms corresponding to an embodiment of the switched capacitor converter shown in FIG. 2A according to the present invention. In one embodiment, as shown in FIG. 3A, in a switching period Tsw1, a duty cycle of the switching control signal S1 and a duty cycle of the switching control signal S2 are both less than 50% (such as the condition of V2<V1/2). In one embodiment, the first inductor current IL1 is equal to the input current (i.e. the first switch current IQ1) during a first ON time Ton1 when the first switch Q1 is at turn-on state. In one embodiment, the current sense circuit 100 is configured to sample the first inductor current IL1 during the first ON time Ton1 to control the current limit for the first switch current IQ1. In another embodiment, the current sense circuit 100 is configured to sample the first inductor current IL1 further during the first switch Q1 is operated at OFF state (during OFF time Toff) for output current limit control for an output current flowing to the second voltage V2.

FIG. 3B shows operating waveforms corresponding to another embodiment of the switched capacitor converter shown in FIG. 2A according to the present invention. In one embodiment, as shown in FIG. 3B, in a switching period Tsw2, a duty cycle of the switching control signal S1 and a duty cycle of the switching control signal S2 are both larger than 50% (such as the condition of V2>V1/2). For further details regarding the waveforms, please refer to the description of FIG. 3A.

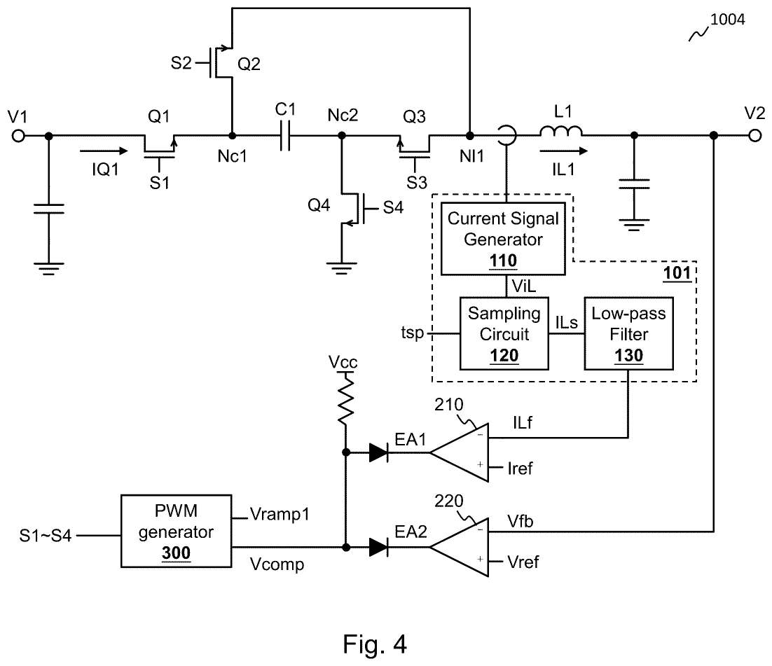

FIG. 4 shows a schematic diagram of a switched capacitor converter according to an embodiment of the present invention. Compared to the switched capacitor converter 1002 shown in FIG. 2, in one embodiment, the switched capacitor converter 1004 in FIG. 4 further comprises a second error amplifier 220. A current sense circuit 101 of the switched capacitor converter 1004 includes a current signal generator 110, a sampling circuit 120 and a low-pass filter 130. In one embodiment, the current signal generator 110 is configured to generate an inductor current signal ViL by detecting the first inductor current IL1. The sampling circuit 120 is configured to sample the inductor current signal ViL during the first ON time Ton1 according to a sampling time tsp, to generate a sampling current signal ILs. A sensed current signal ILf is generated by the sampling current signal ILs through the low-pass filter 130.

In one specific embodiment, the first switch Q1 is coupled between the first voltage V1 and a first capacitor switching node Nc1, the first flying capacitor C1 is coupled between the first capacitor switching node Nc1 and a second capacitor switching node Nc2, the second switch Q2 is coupled between the first capacitor switching node Nc1 and the first inductor switching node Nl1, the third switch Q3 is coupled between the second capacitor switching node Nc2 and the first inductor switching node Nl1, and the fourth switch Q4 is coupled between the second capacitor switching node Nc2 and a ground potential.

In one embodiment, the second error amplifier 220 compares a feedback signal Vfb (or the second voltage V2) with a reference voltage signal Vref to generate a second amplified signal EA2 for controlling the second voltage. In this embodiment, the PWM generator 300 is configured to generate the switching control signals S1˜S4 according to the first ramp signal Vramp1 and a third amplified signal Vcomp. The third amplified signal Vcomp is selected from the lower one between the first amplified signal EA1 and the second amplified signal EA2. The diodes, as an exemplary embodiment as shown in FIG. 4, are configured to compare and select the lower one between the first amplified signal EA1 and the second amplified signal EA2 to generate the third amplified signal Vcomp. From another perspective, each of the loops controlled by the first error amplifier 210 and the second error amplifier 220 determines its respective duty cycle. However, through the comparison and selection mechanism, the loop with the lower duty cycle predominately controls the operation of the switched capacitor converter 1004.

Refer to FIGS. 3A, 3B and 4. In one embodiment, the sampling current signal ILs is sampled from the first inductor current IL1 during the first ON time Ton1 when the first switch Q1 is at turn-on state. Thus, the sampling current signal ILs is proportional to the input current (i.e. the first switch current IQ1) of the switched capacitor converter 1004. Therefore, the switched capacitor converter 1004 senses the input current through the first inductor current IL1 to control the input current. Consequently, the input current sense resistor and the high-voltage current sense amplifier circuit used in prior art are not required in the present invention.

Still referring to FIG. 4, in one embodiment, when the input current (the first switch current IQ1) of the switched capacitor converter 1004 increases, the sensed current signal ILf also increases. If the sensed current signal ILf is higher than the reference current signal Iref, the first error amplifier 210 will pull low the third amplified signal Vcomp to adjust the switching control signals S1˜S4 for controlling the input current under a predetermined input current level.

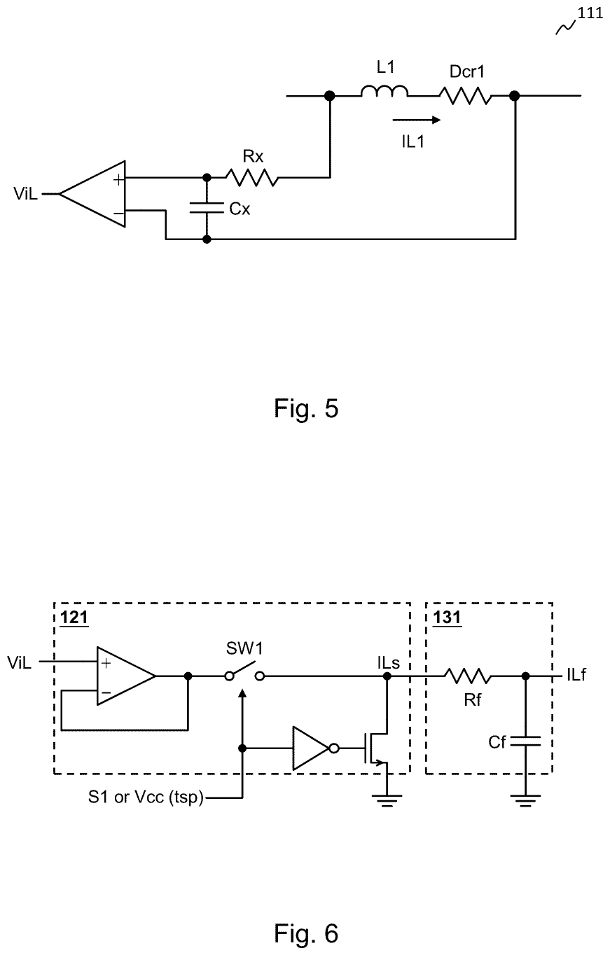

FIG. 5 shows a schematic diagram of a current signal generator of a current sense circuit in a switched capacitor converter according to an embodiment of the present invention. A current signal generator 111 shown in FIG. 5 is a specific embodiment with direct current resistance (DCR) sensing of the current signal generator 110 shown in FIG. 4. In one embodiment, the first inductor L1 includes a direct current resistance Dcr1. The current signal generator 111 includes a sense resistor Rx and a sense capacitor Cx, which are connected in series and coupled with the first inductor L1. The first inductor current IL1 can be sensed from the voltage across the sense capacitor Cx when the time constants are matched for the first inductor L1, the parasitic resistance DCR, sense resistor Rx and sense capacitor Cx. The inductor current signal ViL is generated by the voltage across the sense capacitor Cx. The remaining details of the current signal generator 111 are well known to those skilled in the art and are not elaborated herein.

Note that, the benefit of the above DCR sensing method is to reduce power loss of current sense resistor. The inductor current signal ViL in FIG. 4 is not limited to the DCR sensing method. The inductor current signal ViL can also be generated from a physical current sense resistor in series with the first inductor L1, a current sense transformer, a Hall Effect sense device, the first flying capacitor C1 or at least one the plurality of switches Q1˜Q4.

FIG. 6 shows a schematic diagram of a sampling circuit and a low-pass filter of a current sense circuit in a switched capacitor converter according to an embodiment of the present invention. A sampling circuit 121 and a low-pass filter 131 shown in FIG. 6 are specific embodiments of the sampling circuit 120 and the low-pass filter 130 respectively shown in FIG. 4. In one embodiment, a sampling switch SW1 of the sampling circuit 121 is controlled by a sampling control signal with the sampling time tsp. The sampling control signal can be the switching control signal S1 or a fixed voltage such as Vcc. In one embodiment, when the sampling control signal is the switching control signal S1, the sampling current signal ILs is proportional to the input current flowing through the first switch Q1 (i.e. the first switch current IQ1). In another embodiment, when the sampling control signal is Vcc, the sampling current signal ILs is proportional to the output current corresponding to the second voltage V2.

In one embodiment, the low-pass filter 131 includes a filter resistor Rf and a filter capacitor Cf. The low-pass filter 131 is configured to generate the sensed current signal ILf according to the sampling current signal Ils.

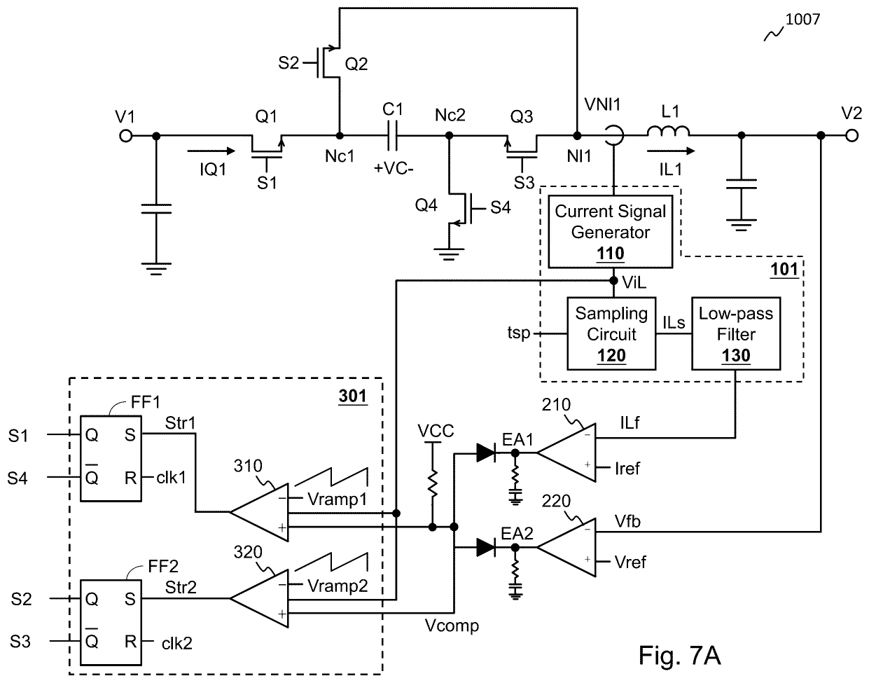

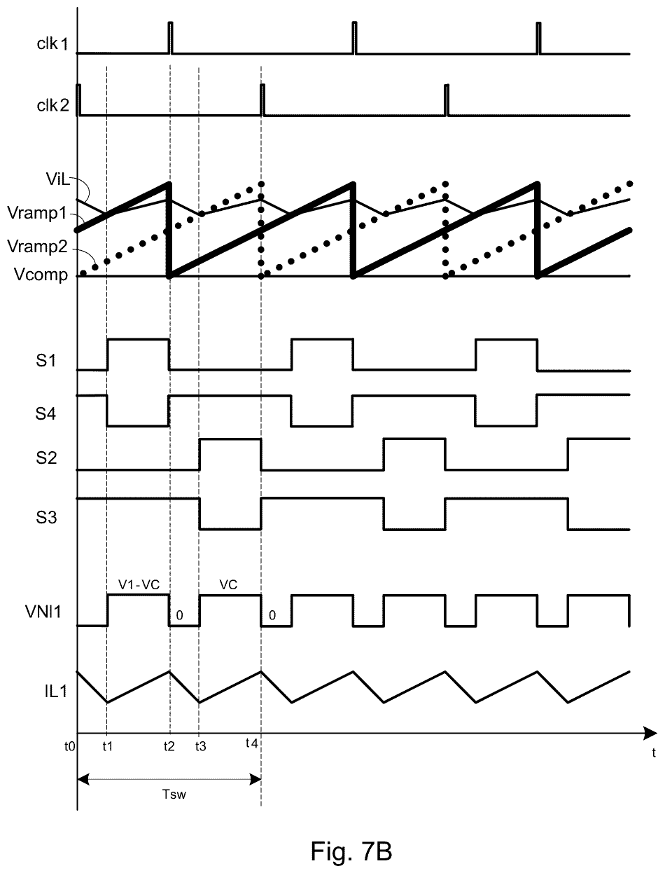

Please refer to FIG. 7A and FIG. 7B. FIG. 7A shows a schematic diagram of a switched capacitor converter according to an embodiment of the present invention. FIG. 7B shows operating waveforms corresponding to the switched capacitor converter shown in FIG. 7A according to an embodiment of the present invention. A switched capacitor converter 1007 shown in FIG. 7A is a specific embodiment corresponding to the switched capacitor converter 1004 shown in FIG. 4. In one embodiment, as shown in FIG. 7A, a PWM generator 301 of the switched capacitor converter 1007 includes a first comparator 310 and a second comparator 320. In one embodiment, the first comparator 310 is configured to compare the third amplified signal Vcomp with the first ramp signal Vramp1 to generate a trigger signal Str1, so as to generate the switching control signals S1 and S4, in conjunction with a flip-flop FF1 based on a clock signal clk1. The second comparator 320 is configured to compare the third amplified signal Vcomp with a second ramp signal Vramp2 to generate a trigger signal Str2 so as to generate the switching control signals S2 and S3, in conjunction with a flip-flop FF2 based on a clock signal clk2. Note that the third amplified signal Vcomp is equivalent to either the first amplified signal EA1 or the second amplified signal EA2 as described earlier. Also note that the first ramp signal Vramp1 and the second ramp signal Vramp2 are generated based on clock signals clk1 and clk2 respectively, and are related to the inductor current signal ViL.

As shown in FIG. 7A, in one embodiment, the first comparator 310 and the second comparator 320 are configured to generate the switching control signals S1˜S4 to control the plurality of switches Q1˜Q4 for controlling the first switch current IQ1 flowing from the first voltage V1, thereby the first inductor switching node Nl1 (i.e., the switching node voltage VNl1) is switched between two of k levels of voltages, such that the first voltage V1 or the second voltage V2 is regulated to a predetermined target level, and a first flying capacitor voltage across the first flying capacitor C1 is regulated and balanced at one (k−1)th of the first voltage V1.

Note that, k mentioned above is an integer equal to or greater than 3 (k is equal to 3 in the embodiment shown in FIG. 7A), and the k levels of voltages include the first voltage V1, a ground potential and at least one divided voltage of the first voltage V1. As shown in FIG. 7B, in this embodiment, the switching node voltage VNl1 is switched between V1/2 (i.e., V1-VC, VC is the voltage across the capacitor C1) and ground potential. Tsw is a switching period in this embodiment. Note that in other embodiment, the switching node voltage VNl1 can be switched between V1 and V1/2.

Still referring to FIG. 7B, in one embodiment, a starting time point (e.g., t1) of a pulse of the first control signal determines a first valley of the first inductor current IL1 (by determining a first valley of the inductor current signal ViL), and a starting time point (e.g., t3) of a pulse of the second control signal determines a second valley of the first inductor current IL1 (by determining a second valley of the inductor current signal ViL), thereby achieving valley current mode control. Also note that, the phase shift between the first ramp signal Vramp1 and the second ramp signal Vramp2 is 180 degrees to ensure balanced control of the switched capacitor converter 1007.

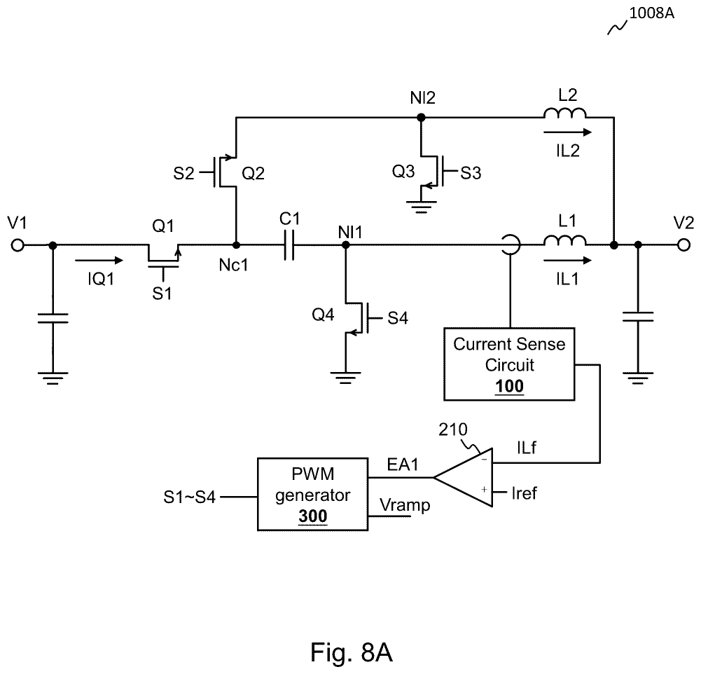

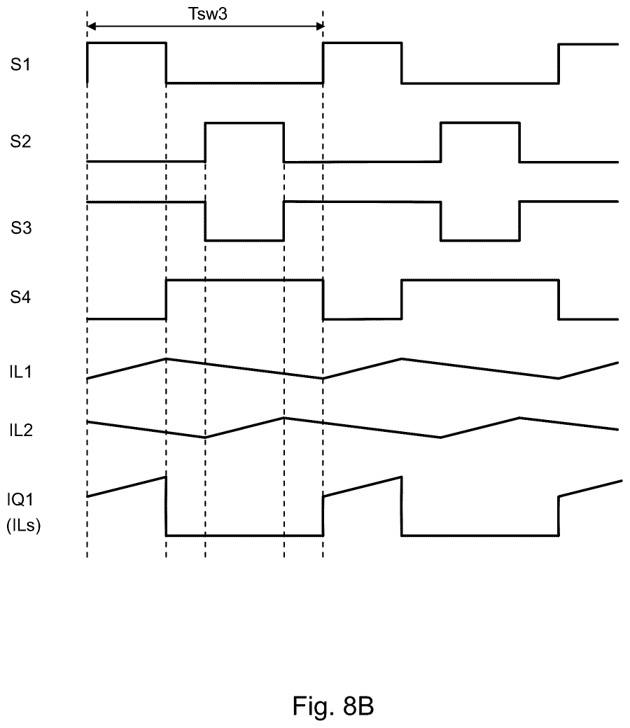

FIG. 8A shows a schematic diagram of a switched capacitor converter according to an embodiment of the present invention. In one embodiment, a switched capacitor converter 1008A further comprises a second inductor L2 with a second inductor current IL2. In one embodiment, the power stage circuit of the switched capacitor converter 1008A is configured as a series capacitor buck SCB converter including the first flying capacitor C1, the first inductor L1, the second inductor L2 and the plurality of switches Q1˜Q4. In one specific embodiment, as shown in FIG. 8A, the first flying capacitor C1 is coupled between the first capacitor switching node Nc1 and the first inductor switching node Nl1, the second switch Q2 is coupled between the first capacitor switching node Nc1 and a second inductor switching node Nl2, the third switch Q3 is coupled between the second inductor switching node Nl2 and a ground potential, the fourth switch Q4 is coupled between the first inductor switching node Nil and a ground potential, and the second inductor L2 is coupled between the second inductor switching node Nl2 and the second voltage V2.

FIG. 8B shows operating waveforms corresponding to the switched capacitor converter shown in FIG. 8A according to an embodiment of the present invention. In one embodiment, in a switching period Tsw3, a duty cycle of the switching control signal S1 and a duty cycle of the switching control signal S2 are both less than 50%. In this embodiment, the current sense circuit 100 is configured to sample the first inductor current IL1 during the first ON time Ton1 when the first switch Q1 is at turn-on state to control the current limit for the first switch current IQ1. The details regarding the operational waveforms in FIG. 8B can be inferred by those skilled in the art from FIG. 8A and the preceding description.

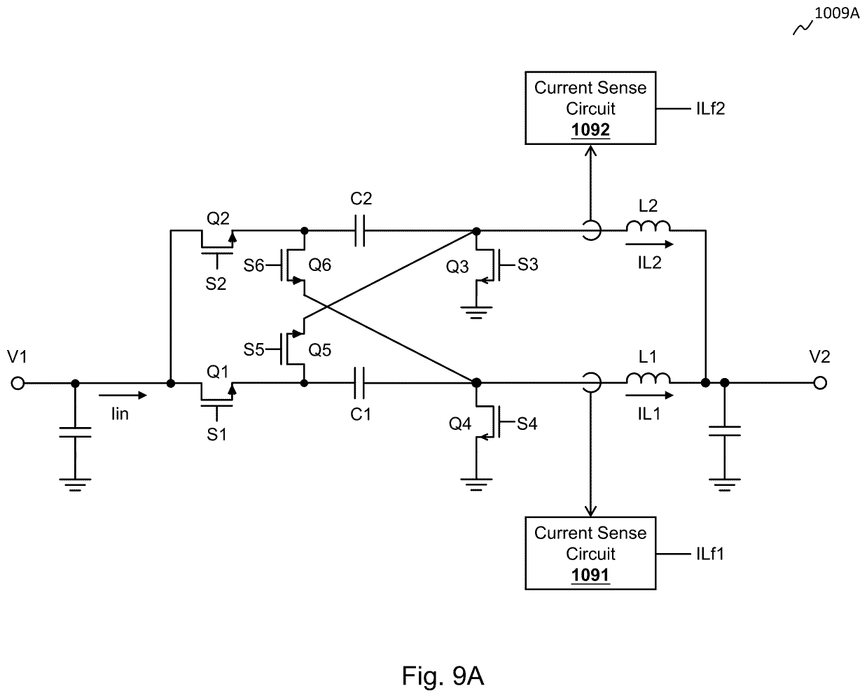

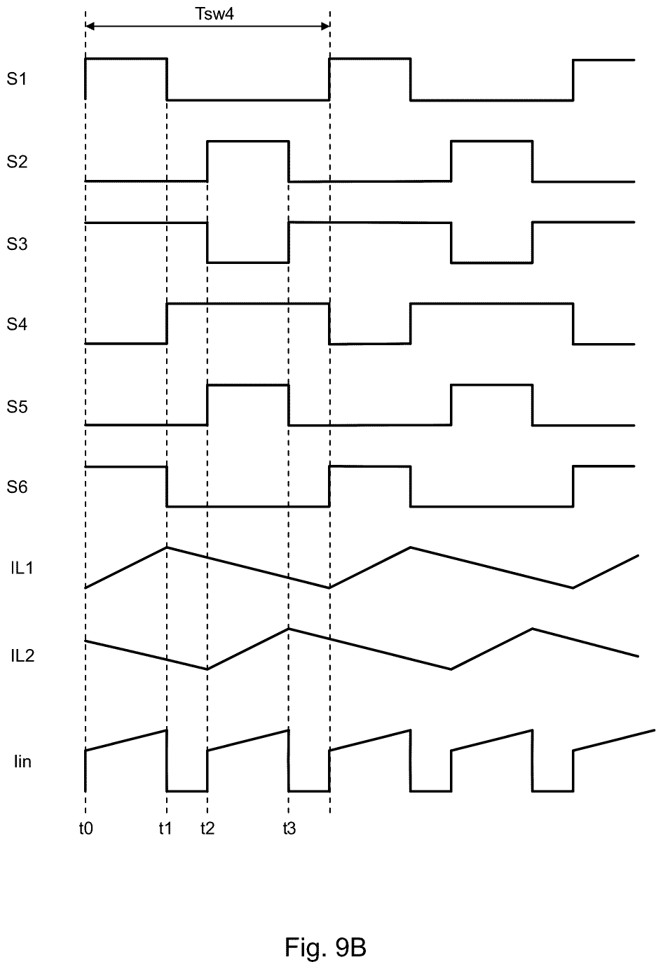

FIG. 9A shows a schematic diagram of a switched capacitor converter according to an embodiment of the present invention. Compared to the switched capacitor converter 1002 shown in FIG. 2, in one embodiment, a switched capacitor converter 1009A further comprises a second inductor L2 and a second flying capacitor C2. The current sense circuit in FIG. 9 includes current sense circuits 1091 and 1092, configured to detect the first inductor current IL1 and the second inductor current IL2 respectively, for generating a first sensed current signal ILf1 and a first sensed current signal ILf2 respectively. In one embodiment, as shown in FIG. 9, the plurality of switches further includes a fifth switch Q5 and a sixth switch Q6, controlled by switching control signals S5 and S6 respectively.

In the embodiment shown in FIG. 9A, the plurality of switches Q1˜Q6, the first inductor L1, the second inductor L2, the first flying capacitor C1, and the second flying capacitor C2 are configured as a cross-coupled switched capacitor converter, for converting the first voltage V1 into the second voltage V2 and vice versa.

Refer to FIGS. 9A and 9B. FIG. 9B shows operating waveforms corresponding to the switched capacitor converter shown in FIG. 9A according to an embodiment of the present invention. In one embodiment, in a switching period Tsw4, a duty cycle of the switching control signal S1 and a duty cycle of the switching control signal S2 are both less than 50%. In one embodiment, as shown in FIG. 9B, during the period t0˜t1, the first inductor current IL1 is magnetized according to a charge current IC1_ch of the first flying capacitor C1 and a discharge current IC2-disch of the second flying capacitor C2. During the period t2-t3, the second inductor current IL2 is magnetized according to a discharge current IC1_disch of the first flying capacitor C1 and a charge current IC2_ch of the second flying capacitor C2. In steady state, the charge current and discharge current are equal for the first flying capacitor C1 and the second flying capacitor C2 due to charge balance. Thus, an average input current value Iina of the input current Iin can be sampled from the first inductor current IL1 while the switching control signal S1 is in the high state and sampled from the second inductor current IL2 while the switching control signal S2 is in the high state. The average input current value Iina can be calculated by the following equations.

$$ILS 1 = IC1\_ch + IC2\_disch \\ ILS 2 = IC1\_disch + IC2\_ch \\ Iina = ( ILS 1 + ILS 2 ) / 2$$

In the above equations, ILS1 is a current value of the first inductor current IL1 while the switching control signal S1 is in the high state, and ILS2 is a current value of the second inductor current IL2 while the switching control signal S2 is in the high state.

In addition, the average input current value Iina can be sampled from the first inductor current IL1 during the switching control signal S1 is high state or sampled from the second inductor current IL2 during the switching control signal S2 is high state if the component parameters are matched between the first flying capacitor C1 and the second flying capacitor C2, and between the first inductor L1 and the second inductor L2.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover all such and other modifications and variations, which should be interpreted to fall within the scope of the following claims and their equivalents.

What is claimed is:

1. A switched capacitor converter configured to convert a first voltage into a second voltage and vice versa, comprising:
a plurality of switches, including at least four switches, with a first switch included, wherein the first switch is coupled between the first voltage and a first inductor switching node;
a first inductor coupled between the first inductor switching node and the second voltage;
a first flying capacitor coupled to the plurality of switches and configured as a capacitive voltage divider to reduce voltage stress to the plurality of switches;
a current sense circuit coupled with the first inductor for detecting a first inductor current flowing through the first inductor and sampling the first inductor current during the first switch's turn-on state to generate a sensed current signal;
a first error amplifier configured to compare the sensed current signal with a reference current signal to generate a first amplified signal; and
a PWM generator configured to compare the first amplified signal with a first ramp signal for generating switching control signals to control the plurality of switches to control a first switch current flowing to or from the first voltage.

2. The switched capacitor converter of claim 1, wherein the current sense circuit includes a sense resistor and a sense capacitor coupled to the first inductor for sensing the first inductor current by sensing the voltage across the sense capacitor to generate the sensed current signal.

3. The switched capacitor converter of claim 1, wherein the current sense circuit includes a sampling circuit and a low-pass filter for detecting the first inductor current and generating the sensed current signal.

4. The switched capacitor converter of claim 1, wherein the current sense circuit samples the first inductor current during the first switch's turn-on state for input current limit control for the first switch current.

5. The switched capacitor converter of claim 1, wherein the current sense circuit samples the first inductor current further during the first switch is operated at OFF state for output current limit control for an output current flowing to the second voltage.

6. The switched capacitor converter of claim 1, wherein the first ramp signal operates with a fixed switching frequency for the switched capacitor converter.

7. The switched capacitor converter of claim 1, further comprising a second error amplifier configured to compare the second voltage with a reference voltage signal to generate a second amplified signal for controlling the second voltage.

8. The switched capacitor converter of claim 1, wherein the switching control signals includes a first switching control signal and a second switching control signal;
wherein the PWM generator includes a first comparator configured to compare the first amplified signal with the first ramp signal for generating the first switching control signal and a second comparator configured to compare the first amplified signal with a second ramp signal for generating second switching control signal, wherein the plurality of switches are controlled by the first switching control signal and the second switching control signal for controlling the first switch current flowing to or from the first voltage;
wherein a starting time point of a pulse of the first control signal determines a first valley of the first inductor current, and a starting time point of a pulse of the second control signal determines a second valley of the first inductor current, thereby achieving valley current mode control for the switched capacitor converter;
wherein the first ramp signal and the second ramp signal are generated based on a first clock signal and a second clock signal respectively, and are related to the inductor current signal.

9. The switched capacitor converter of claim 8, wherein a phase shift between the first ramp signal and the second ramp signal is 180 degrees to ensure balanced control of the switched capacitor converter.

10. The switched capacitor converter of claim 1, further comprising: a second switch, a third switch, and a fourth switch, where the first switch is coupled between the first voltage and a first capacitor switching node, the first flying capacitor is coupled between the first capacitor switching node and a second capacitor switching node, the second switch is coupled between the first capacitor switching node and the first inductor switching node, the third switch is coupled between the second capacitor switching node and the first inductor switching node, and the fourth switch is coupled between the second capacitor switching node and a ground potential.

11. The switched capacitor converter of claim 1, further comprising a second inductor, and the plurality of switches further including a second switch, a third switch, and a fourth switch, wherein the first flying capacitor is coupled between the first capacitor switching node and the first inductor switching node, the second switch is coupled between the first capacitor switching node and a second inductor switching node, the third switch is coupled between the second inductor switching node and a ground potential, the fourth switch is coupled between the first inductor switching node and a ground potential, and the second inductor is coupled between the second inductor switching node and the second voltage.

12. The switched capacitor converter of claim 1, further comprising a second inductor and a second flying capacitor, wherein the plurality of switches, the first inductor, the second inductor, the first flying capacitor, and the second flying capacitor are configured as a cross-coupled switched capacitor converter.

13. A control circuit configured to operably control a switched capacitor converter which is configured to convert a first voltage into a second voltage and vice versa, wherein the switched capacitor converter includes: a plurality of switches which include at least four switches with a first switch included, wherein the first switch is coupled between the first voltage and a first inductor switching node; a first inductor coupled between the first inductor switching node and the second voltage; and a first flying capacitor coupled to the plurality of switches and configured as a capacitive voltage divider to reduce voltage stress to the plurality of switches; wherein the control circuit comprises:
a current sense circuit coupled with the first inductor for detecting a first inductor current flowing through the first inductor and sampling the first inductor current during the first switch's turn-on state to generate a sensed current signal;
a first error amplifier configured to compare the sensed current signal with a reference current signal to generate a first amplified signal; and
a PWM generator configured to compare the first amplified signal with a first ramp signal for generating switching control signals to control the plurality of switches to control a first switch current flowing to or from the first voltage.

14. The control circuit of claim 13, wherein the current sense circuit includes a sense resistor and a sense capacitor coupled to the first inductor for sensing the first inductor current by sensing the voltage across the sense capacitor to generate the sensed current signal.

15. The control circuit of claim 13, wherein the current sense circuit includes a sampling circuit and a low-pass filter for detecting the first inductor current and generating the sensed current signal.

16. The control circuit of claim 13, wherein the current sense circuit samples the first inductor current during the first switch's turn-on state for input current limit control for the first switch current.

17. The control circuit of claim 13, wherein the current sense circuit samples the first inductor current further during the first switch is operated at OFF state for output current limit control for an output current flowing to the second voltage.

18. The control circuit of claim 13, wherein the first ramp signal operates with a fixed switching frequency for the switched capacitor converter.

19. The control circuit of claim 13, further comprising a second error amplifier configured to compare the second voltage with a reference voltage signal to generate a second amplified signal for controlling the second voltage.

20. The control circuit of claim 13, wherein the switching control signals includes a first switching control signal and a second switching control signal;
wherein the PWM generator includes a first comparator configured to compare the first amplified signal with the first ramp signal for generating the first switching control signal and a second comparator configured to compare the first amplified signal with a second ramp signal for generating the second switching control signal, wherein the plurality of switches are controlled by the first switching control signal and the second switching control signal for controlling the first switch current flowing to or from the first voltage;
wherein a starting time point of a pulse of the first control signal determines a first valley of the first inductor current, and a starting time point of a pulse of the second control signal determines a second valley of the first inductor current, thereby achieving valley current mode control for the switched capacitor converter;
wherein the first ramp signal and the second ramp signal are generated based on a first clock signal and a second clock signal respectively, and are related to the inductor current signal.

21. The control circuit of claim 20, wherein a phase shift between the first ramp signal and the second ramp signal is 180 degrees to ensure balanced control of the switched capacitor converter.

22. A control method configured to operably control a switched capacitor converter which is configured to convert a first voltage into a second voltage and vice versa, wherein the switched capacitor converter includes: a plurality of switches which include at least four switches with a first switch included, wherein the first switch is coupled between the first voltage and a first inductor switching node; a first inductor coupled between the first inductor switching node and the second voltage; and a first flying capacitor coupled to the plurality of switches and configured as a capacitive voltage divider to reduce voltage stress to the plurality of switches; wherein the control method comprises:
generating a sensed current signal by detecting a first inductor current flowing through the first inductor and by sampling the first inductor current during the first switch's turn-on state;
generating a first amplified signal by comparing the sensed current signal with a reference current signal; and
generating switching control signals to control the plurality of switches by comparing the first amplified signal with a first ramp signal, to control a first switch current flowing to or from the first voltage.

23. The control method of claim 22, wherein the step of generating the sensed current signal further includes:
sampling the first inductor current to generate a sampling current signal; and
averaging of the sampling current signal to generate the sensed current signal.

24. The control method of claim 22, wherein the step of generating the sensed current signal further includes: sampling the first inductor current during the first switch's turn-on state for input current limit control for the first switch current.

25. The control method of claim 22, wherein the step of generating the sensed current signal further includes: sampling the first inductor current further during the first switch is operated at OFF state for output current limit control for an output current flowing to or from the second voltage.

26. The control method of claim 22, wherein the first ramp signal operates with a fixed switching frequency for the switched capacitor converter.

27. The control method of claim 22, further comprising: generating a second amplified signal for controlling the second voltage by comparing the second voltage with a reference voltage signal.

28. The control method of claim 22, wherein the switching control signals includes a first switching control signal and a second switching control signal, wherein the step of generating the switching control signals includes:
generating the first ramp signal and a second ramp signal based on a first clock signal and a second clock signal respectively, and based on the inductor current signal;
comparing the first amplified signal with the first ramp signal for generating the first switching control signal;
comparing the first amplified signal with the second ramp signal for generating second switching control signal;
controlling the plurality of switches by the first switching control signal and the second switching control signal for controlling the first switch current flowing to or from the first voltage; and
determining a first valley of the first inductor current by a starting time point of a pulse of the first control signal, and determining a second valley of the first inductor current by a starting time point of a pulse of the second control signal, thereby achieving valley current mode control for the switched capacitor converter.

29. The control method of claim 22, wherein a phase shift between the first ramp signal and the second ramp signal is 180 degrees to ensure balanced control of the switched capacitor converter.
